(19) United States
(12) Patent Application Publication
(10) Pub. No.: US 2004/0117763 A1
(43) Pub. Date: Jun. 17, 2004

(54) Persistent object management

(76) Inventors: Jens Fjallstrom, Akerstyckebruk (SE); Magnus Ericson, Huddinge (SE)

Correspondence Address: NIXON & VANDERHYE, PC, 1100 N GLEBE ROAD, 8TH FLOOR, ARLINGTON, VA, 22201-4714, US

(21) Appl. No.: 10/475,261

(22) PCT Filed: Apr. 18, 2001
(86) PCT No.: PCT/SE01/00846

(51) Int. Cl. G06F 9/44

(52) U.S. Cl. 717/108

(57) ABSTRACT

The invention relates to persistent object management and serialization. Serialization is minimized by only storing those objects that have been modified, created or deleted since the last save operation and not objects that are referenced by these modified objects. This is generally accomplished by keeping track, in an object persistence manager (120), of modified objects and storing, for each modified object, the object state together with identification of possible referenced objects in a persistent storage medium (140). At restoration, the objects are restored individually from the persistent storage (140). In order to restore the relationship between objects, the object persistence manager (120) is not only notified of completed restoration of individual objects, but also informed of which objects that are referenced and hence needed by the individually restored objects. Once a referenced object has been restored, the object persistence manager (120) is thus capable of notifying the object that needs the referenced object that restoration of the needed object has been completed and that the actual reference between the objects can be set. The fact that only modified objects are stored minimizes the required serialization and improves the redundant storage performance significantly.

### TECHNICAL FIELD OF THE INVENTION

The present invention generally relates to object-oriented systems, and more particularly to persistent object management, object serialization and restoration of serialized objects.

### BACKGROUND OF THE INVENTION

Today, the predominant paradigm for building software systems is based on object-oriented analysis, design and programming. A wide variety of methods, tools and techniques, including a number of object-oriented programming languages have been developed for the purpose of object-oriented software development over the past fifteen to twenty years. Examples of object-oriented programming languages include C++ which is widely used today, and the increasingly popular Java language.

The ability to store and restore objects is essential to all but the most transient applications, allowing recovery for example at system failure. The key feature to persistent object management is to represent the object state sufficiently well to allow object reconstruction. Serialization is a commonly recognized mechanism for adding persistency to object-oriented applications by requiring objects to save their state in sequential form on a persistent storage medium for later restoration.

In most object-oriented systems, objects frequently refer to other objects. Unfortunately, those other objects must be stored and restored at the same time to maintain the relationship between the objects, for example as specified in the Object Serialization Specification from Sun Microsystems. This means that the present serialization offered today, for example in Java, is not particularly suitable for applications having complex object hierarchies with many object references. With standard serialization, it is not possible to save only those objects that have changed since the last save operation. When an object is serialized, all of the objects that are reachable from this object are stored as well. In the worst-case scenario, the complete object hierarchy has to be serialized each time a single object is modified. Naturally this leads to inefficient and time-consuming object serialization and restoration, which in turn results in poor overall system performance.

### RELATED ART

U.S. Pat. Nos. 5,625,817 and 6,151,607 as well as the International Patent Publication WO 00/55727 all relate to persistent object management in which objects and referenced objects are stored and restored at the same time to maintain the relationship in the object hierarchy.

U.S. Pat. No. 5,437,027 relates to database management supporting object-oriented programming, and especially to persistent object storage in which object references to be stored individually are indicated in the code by a special encapsulated identifier that is recognized by the system precompilator.

U.S. Pat. No. 6,169,993 relates to object state storage, and especially to a repository of stored objects in an interface-based binary object system supporting multiple interfaces. For each object, an object identifier, one or more properties associated with each interface and one or more interface identifiers are stored to enable retrieval of the object state for use in a later created object and also further use of the later created object in the state described by the stored properties.

### SUMMARY OF THE INVENTION

The present invention overcomes these and other drawbacks of the prior art arrangements.

It is a general objective of the present invention to provide an improved strategy for persistent object management.

It is a particular objective of the invention to minimize serialization by providing the ability to store and restore only objects that have been changed or created since the last save operation, while still being able to handle object references.

These and other objectives are met by the invention as defined by the accompanying patent claims. The general idea is to minimize serialization by storing only those objects that have been modified, created or deleted since the last save operation and not objects that are referenced by modified objects. In short, this is generally accomplished by keeping track, in an object persistence manager, of those objects that have been modified since the last save operation, and storing, for each modified object, the object state together with unique identification of possible referenced objects in a persistent storage medium. At restoration, the objects are restored individually from the persistent storage. In order to restore the relationship between objects, the object persistence manager is not only notified of completed restoration of individual objects, but also informed of which objects that are referenced and hence needed by the individually restored objects. Once a referenced object has been restored, the object persistence manager is thus capable of notifying the object that needs the referenced object that restoration of the needed object has been completed and that the actual reference between the objects can be set.

This opens up for individual storage and restoration of objects, allowing serialization of only those objects that have been modified since the last save operation without having to serialize all referenced objects at the same time. The fact that only modified objects are stored minimizes the required serialization and improves the redundant storage performance significantly.

The invention is not dependent on storage method, and can be used in all object-oriented environments that lack the ability to store and restore only modified objects in an efficient way.

According to a preferred embodiment, all objects that are intended to be stored and restored individually implement an interface that defines methods for returning identification of referenced objects and setting object references, as well as methods for read and write of referenced object identification and object state data.

Preferably, the object persistence manager is divided into a state storage manager responsible for keeping track of the object modifications and the state storage operations, a restore factory for controlling the actual restoration of objects as well as a restore manager for managing restored objects, getting information on which objects that are referenced by a restored object and informing objects when a referenced object has been restored.

The invention offers the following advantages:

Minimized serialization;

Improved redundant storage performance as well as overall system performances

Generally applicable to object-oriented software environments.

Other advantages offered by the present invention will be appreciated upon reading of the below description of the embodiments of the invention.

### BRIEF DESCRIPTION OF THE DRAWINGS

The invention, together with further objects and advantages thereof, will be best understood by reference to the following description taken together with the accompanying drawings, in which:

FIG. 1 is a schematic high-level block diagram of a system for persistent object management according to a preferred embodiment of the invention;

FIGS. 2A-C are schematic diagrams illustrating a typical save scenario according to the invention;

FIGS. 3A-F are schematic diagrams illustrating a typical scenario for restoring an object and its relationship to a referenced object according to the invention;

FIGS. 4A-B all together define a schematic sequence diagram of a serialization procedure according to the invention;

FIG. 5 is a schematic diagram illustrating an exemplary object graph; and

FIGS. 6A-B all together define a schematic sequence diagram of a restoration procedure according to a preferred embodiment of the invention.

### DETAILED DESCRIPTION OF EMBODIMENTS OF THE INVENTION

Throughout the drawings, the same reference characters will be used for corresponding or similar elements.

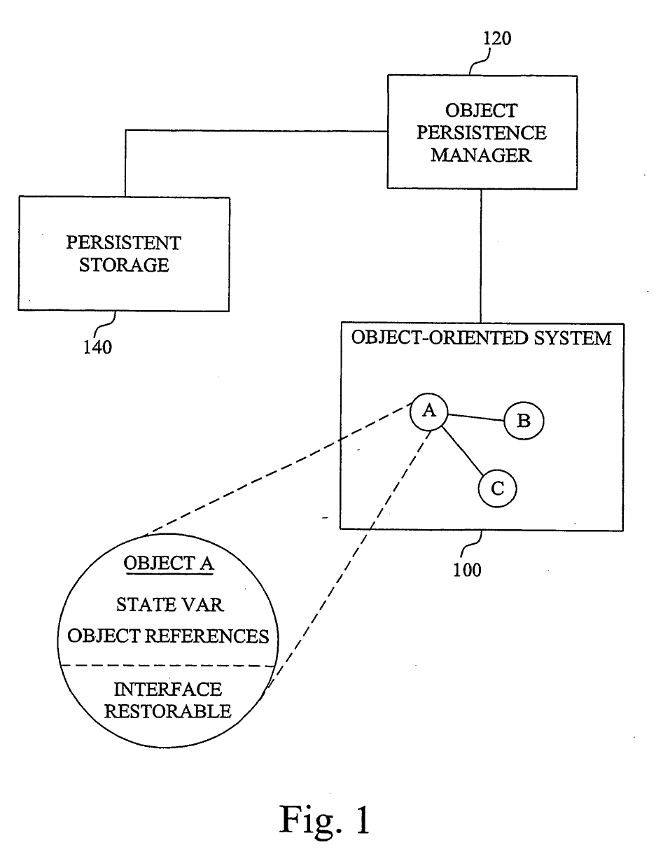

The invention will now be described with reference to an illustrative example of a system for persistent object management. It is useful to begin with a general overview of the illustrative object management system proposed by the invention by referring to FIG. 1.

General Overview

FIG. 1 is a schematic high-level block diagram of a system for persistent object management according to a preferred embodiment of the invention. The object management system interacts with an object-oriented system 100 and basically comprises an object persistence manager 120 and a persistent storage structure 140. The idea is to minimize serialization by storing only those objects that have been modified, created or deleted since the last save operation and not objects that are referenced by modified objects. In short, this is generally accomplished by keeping track, in the object persistence manager 120, of those objects that have been modified since the last store operation, and storing, for each modified object, the object state together with unique identification of possible referenced objects in the persistent storage 140. At restoration, the objects are restored individually from the persistent storage 140. In order to restore the relationship between objects, the object persistence manager 120 is not only notified of completed restoration of individual objects, but also informed of which objects that are referenced and hence needed by the individually restored objects. Once a referenced object has been restored, the object persistence manager 120 is thus capable of notifying the object that needs the referenced object that restoration of the needed object has been completed and that the actual reference between the objects can be set.

In general, the object persistence manager 120 is responsible for:

Keeping track of modified, created and deleted objects.

Initiating reconstruction of the external object structure based on class definition and object identification information.

Keeping track of restored and needed objects.

Informing objects when needed objects have been restored.

Initiating the actual save and restore operations.

For each application, it is defined what type of object changes that will result in a notification to the object persistence manager of an object modification. In general, the creation of new objects and the deletion of existing objects as well as changes in object state are regarded as object modifications.

In accordance with a preferred embodiment of the invention, any object that is to be restored individually implements an interface ‘Restorable’ that defines methods for handling object references and for read and write of the object state and object references. In most cases, the interface also defines a method for retrieving the object identification for referenced objects. The object references are usually normal variables in an object. However, the object references may also be in the form of private variables, which means that some type of access method is required in order to retrieve the reference identification from the referenced object.

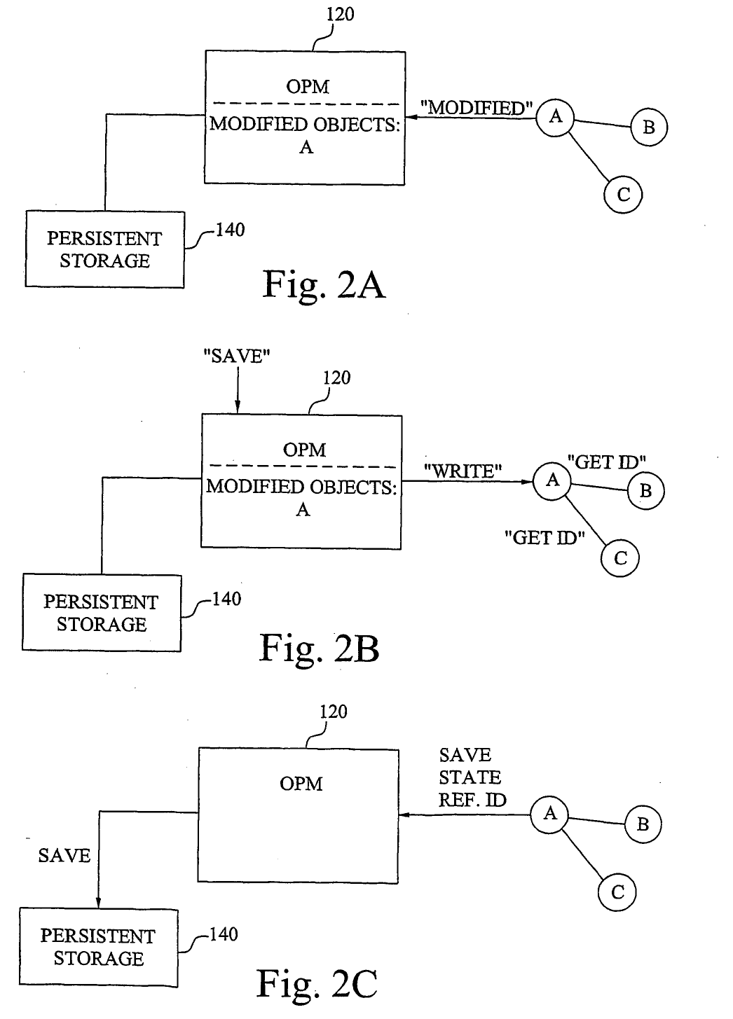

FIGS. 2A-C are schematic diagrams illustrating a typical save scenario according to the invention. When object A changes its state, it reports to the object persistence manager (OPM) 120 that it has been modified and the OPM 120 adds object A to a list of modified objects, as can be seen in FIG. 2A. Once the application has reached a stable state, it issues a “save” command to the OPM to initiate state storage (FIG. 2B). Now, the OPM normally issues a “write” command to the modified object A, and object A retrieves the identification for each of the referenced objects B and C by means of the “get id” command. Subsequently, as shown in FIG. 2C, object A saves its object state and the identification for each of the objects B and C to the persistent storage 140, either directly or via the OPM 120. Hence, the referenced objects B and C will not be stored in response to a modification of object A, it is only the object identification for these objects that is stored. This will reduce the required serialization and improve the performance significantly, compared to storing all of the objects A, B and C.

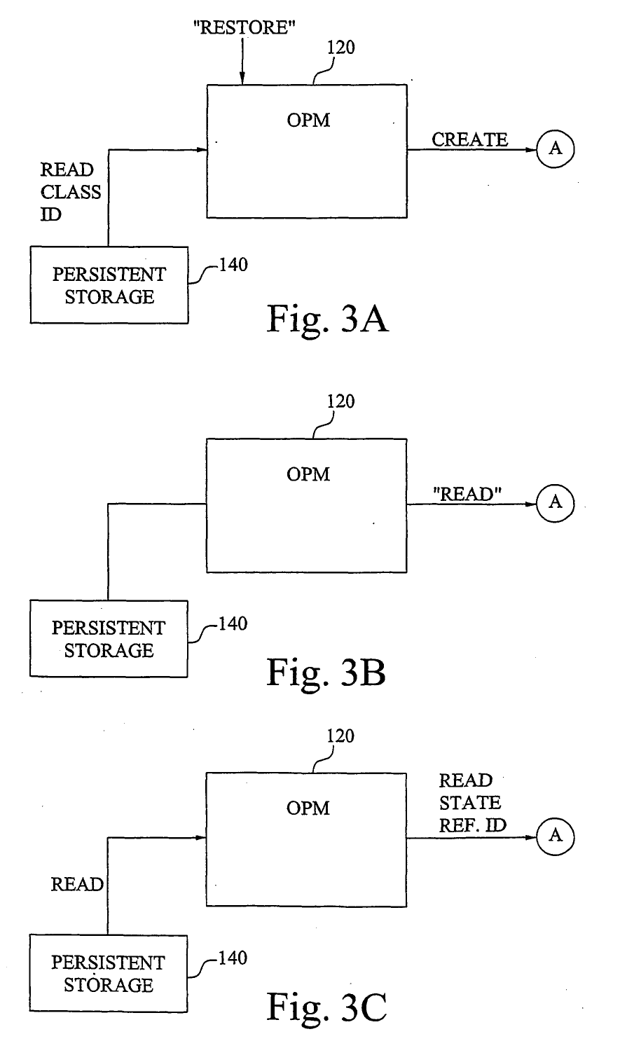

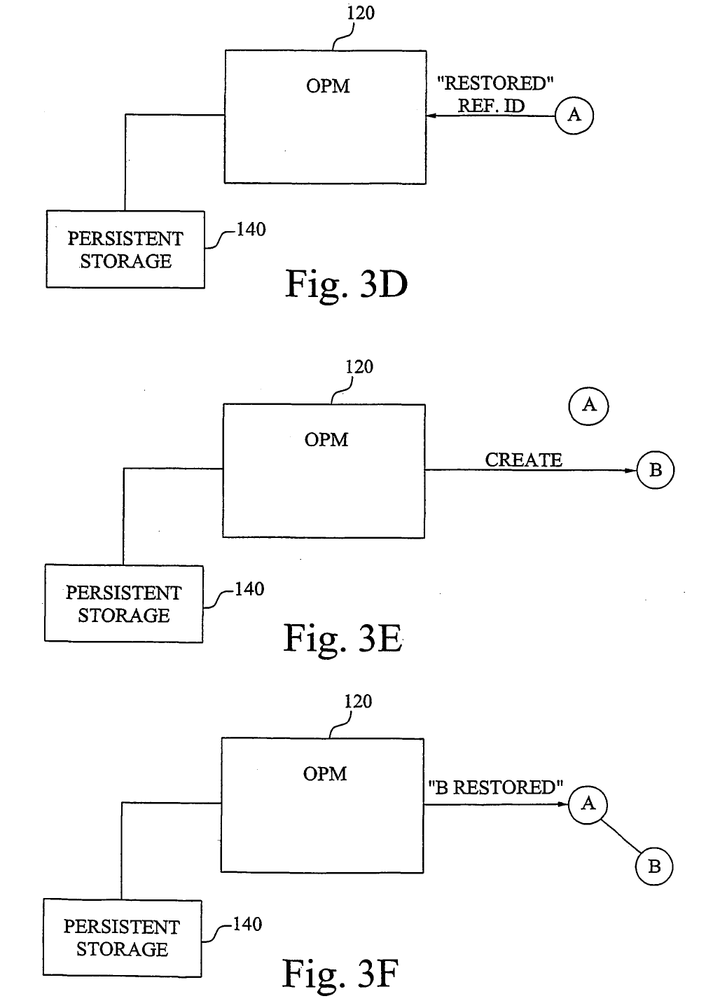

FIGS. 3A-F are schematic diagrams illustrating a typical scenario for restoring an object and its relationship to a referenced object according to the invention. The system application normally issues a “restore” command to the OPM as and when required by the specific application, for example at system failure. When a specific object, A, is to be restored, the OPM 120 will read class and identification data for the object from the persistent storage 140 and create the external structure of object A based on this information, as seen in FIG. 3A. The OPM 120 will then issue a “read” command to object A (FIG. 3B), instructing object A to read (FIG. 3C) its object state as well as the object identification for each referenced object from the persistent storage 140, either directly or via the OPM. When object A has restored its state it will report to the OPM that it has been “restored”, and the OPM will also be informed of the identification of each referenced object needed by object A, as seen in FIG. 3D. Next, the OPM 120 will recreate the object, B, in more or less the same manner as object A was recreated. Once object B has been fully restored, it will inform the OPM. Now, the OPM checks its internal database to see which objects that need object B, and inform the relevant objects of the presence of object B (FIG. 3F). Object A that needed a reference to object B can now restore the object reference. Naturally, the object reference to object C (not shown) can be restored in the same way.

In this way, it is possible to serialize only those objects that have been modified since the last save operation without having to store all referenced objects at the same time. The fact that only modified objects are stored minimizes the required serialization and improves the redundant storage performance.

For a better understanding, the invention will now be described with reference to a detailed example of a persistent object management system that is customized for implementation in Java. It should though be understood that the invention is not limited thereto, and that the invention can be realized in any object-oriented programming language.

Implementation in Java

For general information on serialization and restoration of serialized objects in Java, reference can be made to the Object Serialization Specification from Sun Microsystems.

In the following illustrative implementation, which is one of many possible implementations, the object persistence manager is divided into a state storage manager, a restore factory and restore manager, which are implemented by the corresponding classes StateStorage, RestoreFactory and RestoreManager, respectively.

Restorable

The ‘Restorable’ interface is implemented by any object that is to be individually restored, and such an individually restorable object is sometimes simply referred to as a ‘restorable’. The interface includes methods to set and get the unique id of the object (setting the id is only possible in the object constructor of Java), to handle references to other restorable objects and to read/write object information to object input/output streams.

A definition of the ‘Restorable’ interface according to a preferred embodiment of the invention is given below:

public interface Restorable {

// public <CONSTRUCTOR>(Object id);
Object getId( );
Set getNeeded( );
void setNeeded(Restorable needed);
void read(ObjectInput i) throws IOException,
ClassNotFoundException;
void write(ObjectOutput o) throws IOException;
// static void skip(ObjectInput i);

}

Each object that implements the ‘Restorable’ interface must create a unique id in the constructor. The same unique id will be provided when the object is restored. The getNeeded method returns, for a given restorable, a set of ids for other restorable objects that are referenced by the given restorable and that need to be restored before the given restorable is complete. The setNeeded method is called by the RestoreManager every time a restorable with an id listed in the returned result of the getNeeded method has been restored.

The read and write methods are called by the StateStorage when restoring/saving objects to replicated and/or persistent storage. The skip method is used to skip the bytes associated with a serialized object without creating a new object of the class. This method as well as the constructor are only shown as comments since interfaces can not contain static methods.

StateStorage

The ‘StateStorage’ interface keeps track of which objects that have been created, deleted or modified since the last invocation of the save method and stores the objects when the save method is invoked the next time. No database or transaction mechanism is required. Instead a linked list of variable length byte arrays is normally used. Any type of underlying storage that can implement a linked list of variable length byte arrays can be used by the StateStorage. Managed objects are preferably stored in marshalled form (i.e. as byte arrays). All the objects that need to be saved in one save operation is marshalled and concatenated to one variable length byte array. When a managed object is deleted only the id is marshalled instead of the whole object. New byte arrays are always added at the end of the list but a deletion can occur anywhere in the list. During restore the list is always read starting with the most recent byte array towards the oldest. It is also assumed that each read/write/delete operation to the underlying storage is atomic, i.e. either performed in full or not at all.

The StateStorage includes an algorithm that detects records, written to the underlying storage, that have become obsolete and therefore can be removed, and another algorithm that prevents the number of records in the underlying store from exceeding a specified maximum threshold.

The state storage manager generally has methods for the following purposes:

Notification that a new object shall be stored.

Notification that an object has changed.

Notification that an object has been deleted.

Saving all modifications (including new and deleted objects) to the underlying storage medium.

Retrieving all objects stored in the underlying storage media.

To speed up the save operation and to avoid the need of simultaneous read/write access to the underlying storage, a number of internal data structures are required. These structures are fully rebuilt by reading the contents of the underlying storage. During each save operation the internal data structures are searched to find obsolete byte arrays in the underlying store that can be deleted. At the same time, if the maximum threshold is reached, the most suitable byte array for removal is selected. For example, the byte array that contains the smallest number of objects that are still valid (i.e. objects that are not present in newer byte arrays) can be removed. If writing a new record causes the underlying store to reach its specified maximum size, all valid data in the byte array selected for removal is added to the new record and the removal candidate is marked as obsolete. When the new byte array has been successfully written all the obsolete byte arrays are removed.

RestoreFactory

The ‘RestoreFactory’ interface handles the creation of objects during restore based on class definition and object id information from the StateStorage.

RestoreManager

The ‘RestoreManager’ class interacts with the restorable objects while they are being restored. The main function is to keep track of all the dependencies between the restorable objects and to allow objects that are restored before their dependent objects to fill in the missing object references once the missing objects are restored. The RestoreManager uses the getNeeded method of each restorable object to find the ids of all referenced restorable objects. When a restorable that is “needed” by some other object is read, the referring object is given the id of the needed restorable by the RestoreManager using the setNeeded method.

Example of Serialization and Restoration

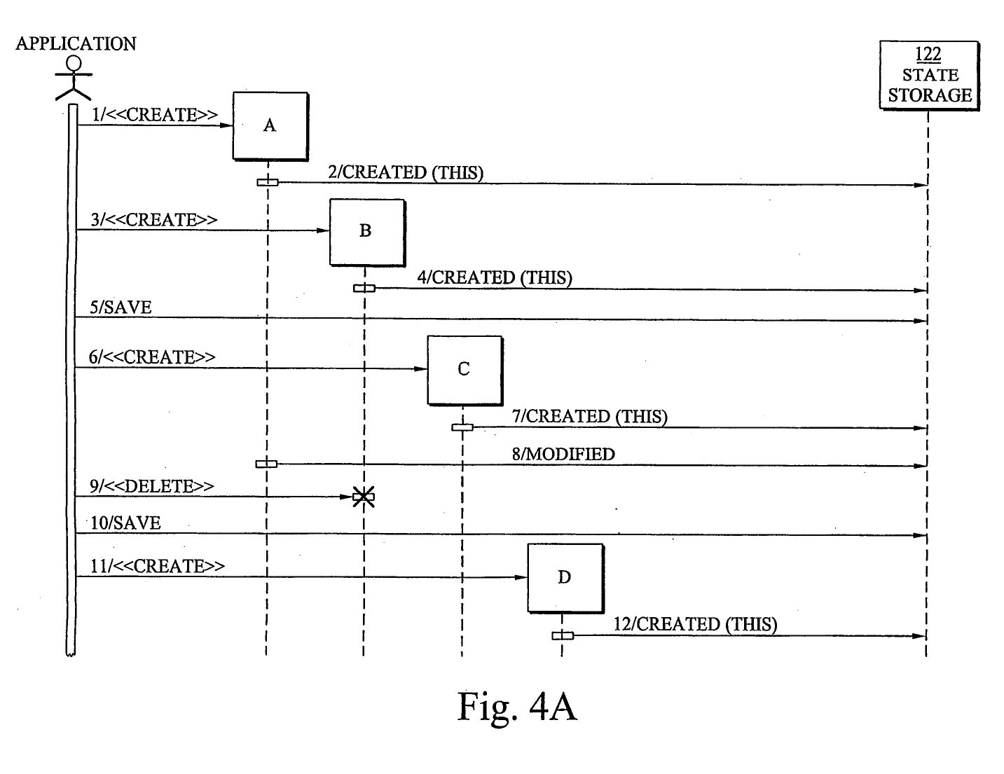

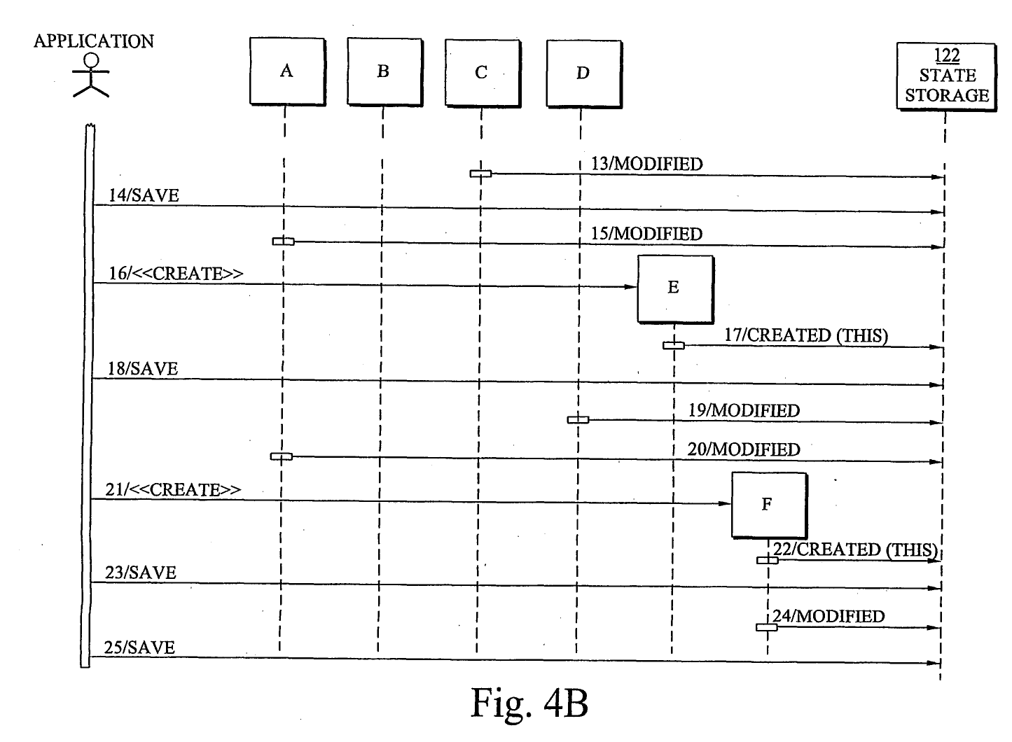

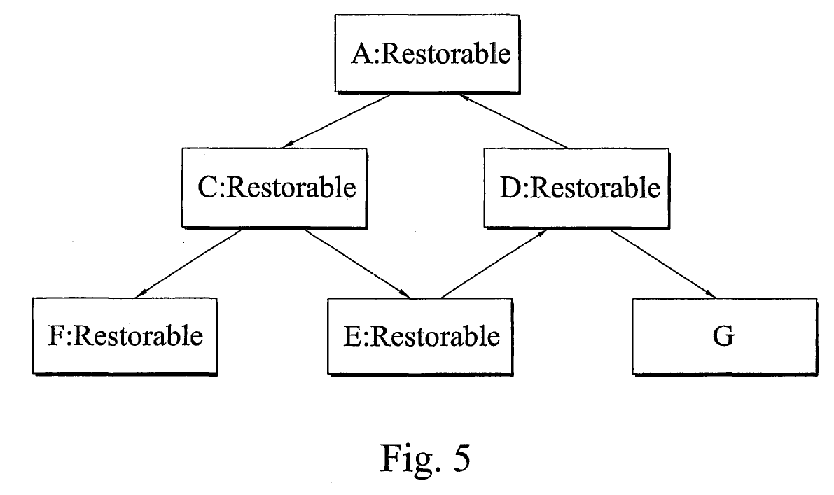

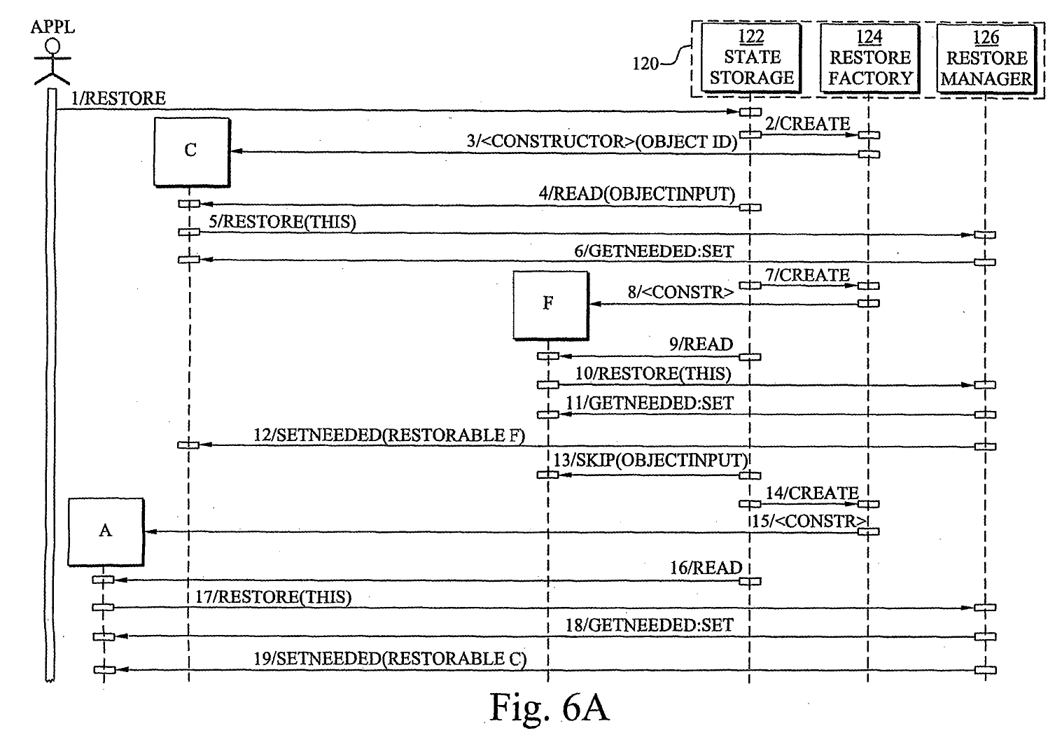

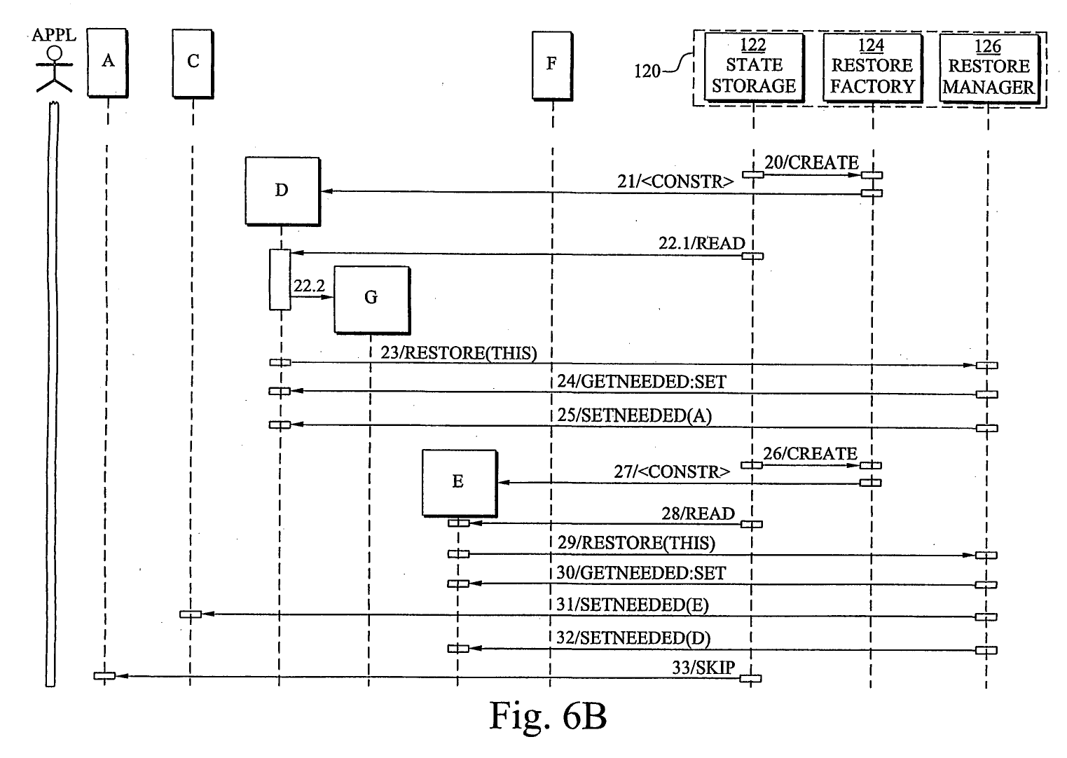

The following example will explain how objects are serialized and subsequently restored. In the first section, described with reference to FIGS. 4A-B, a number of objects are created, changed and deleted. This will result in a stable state of a number of objects in the persistent storage. The objects and their relationship are illustrated in FIG. 5. It is of no importance to this example how the relations in FIG. 5 has emerged. It is only important to realize that this is the object graph to be restored. The last section, described with reference to FIGS. 6A-B, illustrates how the system is restored to the stable state.

The state of the storage will be described by [number of created objects, object 1, . . . , object N, number of deleted objects, deleted object ids]. The underlined objects are the valid objects, i.e. the objects that will be restored when the application issues a restore request to the StateStorage. In this example the maximum limit for the storage is three records. The value specified in connection with each object in this example is just a simple a way of illustrating the state of the object.

Referring to FIGS. 4A-B, the following events occur:

1. Object A is created, A=1.

2. Object A reports to the StateStorage 122 that it has been created.

3. Object B is created B=100.

4. Object B reports to the StateStorage that it has been created.

5. The application requests the StateStorage to save the current state.

Storage:

2,A=1,B=100,0

6. Object C is created, C=200.

7. Object C reports to the StateStorage that it has been created.

8. Object B is deleted.

9. Object A is modified and reports this to the StateStorage, A=2.

10. The application requests the StateStorage to save the current state.

Storage:

2,A=1,B=100,0

2,C=200,A=2,1,B

Since both A and B are stored in the new record, the first record is obsolete and can be removed.

11. Object D is created, D=300.

12. Object D reports to the StateStorage that it has been created.

13. Object C is modified and reports this to the StateStorage, C=201.

14. The application requests the StateStorage to save the current state.

Storage:

2,C=200,A=2,1,B

2,D=300,C=201,0

15. Object A is modified and reports this to the StateStorage, A=3.

16. Object E is created, E=400.

17. Object E reports to the StateStorage that it has been created.

18. The application requests the StateStorage to save the current state.

Storage:

2,C=200,A=2,1,B

2,D=300,C=201,0

2,A=3,E=400,0

The first record is now obsolete since A and C are in the two other records and the deleted object B is no longer anywhere in the storage.

19. Object E is modified and reports this to the StateStorage, E=401.

20. Object A is modified and reports this to the StateStorage, A=4.

21. Object F is created, F=500.

22. Object F reports to the StateStorage that it has been created.

23. The application requests the StateStorage to save the current state.

Storage:

2,D=300,C=201,0

2,A=3,E=400,0

3,D=301,A=4,F=500,0

24. Object F is modified and reports this to the StateStorage, F=501.

25. The application requests the StateStorage to save the current state.

A new record has to be generated for storing the modification of F. Since the limit of three records in the storage has already been reached, we have to merge a previous record into the new record and remove the previous record.

The first and second records are equally suitable for merging into the new record, since they both contain one valid element. In this example, the first record is merged into the new record and removed. Storage after merging of the first record into the new record and removal of the first record:

2,A=3,E=400,0

3,D=301,A=4,F=500,0

2,F=501,C=201,0

In order to describe the operations involved when the last saved state is to be restored it is necessary to know the relationship between the objects. The relationship between the objects is illustrated in the object graph of FIG. 5. It should be noted that object G has been added to illustrate how an object that does not implement the ‘Restorable’ interface is handled during restoration of the system. All other objects are restorable objects, each of which saves the ids of referenced objects together with the object state using the ObjectOutput during serialization.

The order in which the objects are restored is arbitrary and the solution for restoration of the last saved state is independent of the order. In this example the objects are restored from the end of the storage:

2,A=3,E=400,0

3,D=301,A=4,F=500,0

2,F=501,C=201,0

Referring to FIGS. 6A-B, the following events occur:

1. When the system is to be restored the restore method in the StateStorage 122 is called by the application.

2. The most recently saved object in the storage is object C, and therefore object C is the first object to be restored. The StateStorage 122 requests the RestoreFactory 124 to create object C with the provided class and id.

3. The RestoreFactory 124 creates object C using the constructor.

4. The StateStorage 122 requests object C to read its data. Object C uses the ObjectInput provided to read the data and the id for the saved references.

5. When Object C has completed the read operation it informs the RestoreManager 126 that it has been restored.

6. The RestoreManager 126 calls the getNeeded method on object C to obtain the ids for the restorable(s) that C needs to reference. In this case the returned set will include the ids for objects E and F.

7. The next object to restore is object F, and the StateStorage 122 requests the RestoreFactory 124 to create object F with the provided class and id.

8. The RestoreFactory 124 creates object F.

9. The StateStorage 122 requests object F to read its data. Object F uses the ObjectInput provided to read the data and the id for the saved references.

10. When Object F has completed the read operation it informs the RestoreManager 126 that it has been restored.

11. The RestoreManager 126 calls the getNeeded method on object F to obtain the ids for the restorable(s) that F needs to reference. In this case the returned set will not contain any ids since F does not reference any restorable objects.

12. The RestoreManager 126 keeps track of all needed objects and can now inform object C that object F is present. This is done by calling the setNeeded method on object C. In the setNeeded method, object C can set the actual reference to object F.

13. The next object read by the StateStorage 122 from the storage media is object F (invalid). Since object F has already been restored, the skip method on object F is called. In the skip method, object F will read the object state data and the id for the references from the storage and simply discard it.

14. The StateStorage 122 requests the RestoreFactory 124 to create object A with the provided class and id.

15. The RestoreFactory 124 creates object A.

16. The StateStorage 122 requests object A to read its data. Object A uses the ObjectInput provided to read the data and the id for the saved references.

17. When Object A has completed the read operation it informs the RestoreManager 126 that it has been restored.

18. The RestoreManager 126 calls the getNeeded method on object A to obtain the ids for the restorable(s) that A needs to reference. In this case the returned set will contain the id for object C.

19. Since object C has already been restored, the RestoreManager 126 can inform object A that object C is present.

20. The StateStorage 122 requests the RestoreFactory 124 to create object D with the provided class and id.

21. The RestoreFactory 124 creates object D.

22.1. The StateStorage 122 requests object D to read its data. Object D uses the ObjectInput provided to read the object state data and the id for the saved references.

22.2 In the object state data, a reference to the non-restorable G is found.

23. When Object D has completed the read operation it informs the RestoreManager 126 that it has been restored.

24. The RestoreManager 126 calls the getNeeded method on object D to obtain the ids for the restorable(s) that D needs to reference. In this case the returned set will contain the id for object A. The returned set will not contain any id for object G since G is not a restorable.

25. Since object A has already been restored, the RestoreManager 126 can inform object D that object A is present.

26. The StateStorage 122 requests the RestoreFactory 124 to create object E with the provided class and id.

27. The RestoreFactory 124 creates object E.

28. The StateStorage 122 requests object E to read its data. Object E uses the ObjectInput provided to read the data and the id for the saved references.

29. When Object E has completed the read operation it informs the RestoreManager 126 that it has been restored.

30. The RestoreManager 126 calls the getNeeded method on object E to obtain the ids for the restorable(s) that A needs to reference. In this case the returned set will contain the id for object D.

31. Object C is informed that object E is present and that the reference can be restored.

32. Object E is informed that object D is present and the reference can be restored.

33. The last object that is read from the storage is A, and since A has already been restored the skip method is called and A can read the data from the storage and discard it.

After these steps, all objects will be in the same state as they were on the last save. Consequently, it can be appreciated that it is possible to fully restore the object graph of FIG. 5 by using the persistent object management system proposed by the invention.

The embodiments described above are merely given as examples, and it should be understood that the present invention is not limited thereto. Further modifications, changes and improvements which retain the basic underlying principles disclosed and claimed herein are within the scope and spirit of the invention.

1. A method of persistent object management based on intermittent state storage to a persistent storage medium (140), characterized by:
keeping track, in an object persistence manager (120), of object modifications;
performing a state storage operation for each modified object, wherein said state storage operation involves, for at least one modified object, storage of unique identification of at least one referenced object;
restoring, in accordance with instructions from the object persistence manager (120), said at least one modified object and a reference to said at least referenced object by:
constructing the external object structure of said at least one modified object based on class definition and object identification information from said storage medium (140);
reading the object state of said at least one modified object and said unique identification of at least one referenced object from said storage medium (140);
notifying the object persistence manager (120) of completed restoration of said at least one modified object;
informing the object persistence manager (120) of said unique identification of said at least one referenced object to enable the object persistence manager to notify said at least one modified object when said at least one referenced object has been fully restored, thereby completing the restoration of said at least one modified object and the reference to said at least one referenced object.

2. The method according to claim 1, characterized in that said at least one modified object and said at least one referenced object implement an interface for allowing individual object storage and restoration, said interface having methods for handling object references and for read and write of referenced object identification and object state data.

3. The method according to claim 2, characterized in that said interface includes methods for returning identification of a referenced object in response to a request from said object persistence manager (120) and for setting an object reference in response to a notification of a restored referenced object from said object persistence manager (120) in order to handle object references.

4. The method according to any of the preceding claims, characterized in that said method further comprises the steps of:
constructing the external object structure of said at least one referenced object based on class definition and object identification information from said storage medium (140); and
reading the object state of said at least one referenced object from said persistent storage medium (140); and
notifying the object persistence manager (120) of completed restoration of said at least one referenced object.

5. The method according to any of the preceding claims, characterized in that said method further comprises the step of defining what type of object changes that will result in a notification to the object persistence manager (120) of an object modification.

6. The method according to claim 5, characterized in that the creation of a new object and the deletion of an object are regarded as object modifications.

7. A method of object serialization, characterized by:
keeping track of object modifications;
performing a serialization operation for each modified object, wherein said serialization operation involves, for at least one modified object, storage of unique identification of at least one referenced object.

8. The method according to claim 7, characterized in that said at least one modified object and said at least one referenced object implement an interface for allowing individual object storage and restoration, said interface having methods for handling object references and for read and write of referenced object identification and object state data.

9. The method according to claim 7 or 8, characterized in that said method further comprises the step of defining what type of object changes that will be regarded as an object modification.

10. The method according to claim 9, characterized in that the creation of a new object and the deletion of an object are regarded as object modifications.

11. A method of restoring serialized objects from a storage medium (140), characterized in that a number of objects in an object-oriented system implement an interface for allowing individual object storage and restoration, said interface having methods for forwarding identification of referenced objects and for setting object references as well as methods for read and write of referenced object identification and object state data, and said restoring method comprises the steps of:
constructing, for at least one object provided with said interface, the external object structure based on class definition and object identification information from said storage medium (140);
reading the object state together with unique identification of at least one referenced object from said storage medium (140);
notifying an object persistence manager (120) of completed restoration of said at least one object;
informing the object persistence manager (120) of said unique identification of said at least one referenced object to enable the object persistence manager to notify said at least one object when said at least one referenced object has been fully restored, thereby completing the restoration of said at least one object and the reference to said at least one referenced object.

12. The method according to claim 11, characterized in that said method further comprises the steps of:
constructing the external object structure of said at least one referenced object based on class definition and object identification information from said storage medium (140); and
reading the object state of said at least one referenced object from said storage medium (140); and
notifying the object persistence manager (120) of completed restoration of said at least one referenced object.

13. A system for persistent object management based on intermittent state storage to a persistent storage medium (140), characterized by:
a state storage manager (122) for keeping track of object modifications and for storing, for each modified object, the object state together with identification of possible referenced objects in said storage medium (140);
a restore factory (124) for controlling restoration of objects from said storage medium (140); and
a restore manager (126) for keeping track of restored objects and needed referenced objects based on notifications of completed object restoration from said objects and identification of referenced objects, and for informing restored objects when the corresponding needed referenced objects have been restored so that the actual object references can be set.

14. The system according to claim 13, characterized in that said objects implement an interface for allowing individual object storage and restoration, said interface having methods for:
returning identification of a referenced object in response to a request from said restore manager (126);
setting an object reference in response to a notification of a restored referenced object from said restore manager (126); and
read and write of referenced object identification and object state data.

15. The system according to claim 13 or 14, characterized in that said system further comprises:
means for constructing the external structure of an object to be restored based on class definition and object identification information from said storage medium (140); and
means for reading, in accordance with instructions from said state storage manager (122), the object state and the referenced object identification from said storage medium (140); and
means for notifying the restore manager (126) of completed restoration of said object and for informing the restore manager of the referenced object identification.

16. The system according to claims 15, characterized in that said system further comprises means for defining what type of object changes that will result in a notification to the state storage manager of an object modification.

17. The system according to claim 16, characterized in that the creation of a new object and the deletion of an object are regarded as object modifications.

18. A system for object serialization, characterized by:
means (120; 122) for keeping track of object modifications;
means for performing a serialization operation for each modified object, wherein said serialization operation involves, for at least one modified object, storage of unique identification of at least one referenced object.

19. The system according to claim 18, characterized in that said at least one modified object and said at least one referenced object implement an interface for allowing individual object storage and restoration, said interface having methods for handling object references and for read and write of referenced object identification and object state data.

20. The system according to claim 18 or 19, characterized in that said system further comprises means for defining what type of object changes that will be regarded as object modifications.

21. The system according to claim 20, characterized in that the creation of a new object and the deletion of an object are regarded as object modifications.

22. A system for restoring serialized objects from a storage medium (140), characterized in that a number of objects in an object-oriented system implement an interface for allowing individual object storage and restoration, said interface having methods for forwarding identification of referenced objects and for setting object references as well as methods for read and write of referenced object identification and object state data, and said system comprises:
means for constructing, for at least one object provided with said interface, the external object structure based on class definition and object identification information from said storage medium (140);
means for reading the object state together with unique identification of at least one referenced object from said storage medium (140);
means for notifying an object persistence manager (120) of completed restoration of said at least one object;
means for informing the object persistence manager (120) of said unique identification of said at least one referenced object to enable the object persistence manager (120) to notify said at least one object when said at least one referenced object has been fully restored, thereby completing the restoration of said at least one object as well as the reference to said at least one referenced object.

23. The system according to claim 22, characterized in that said system further comprises:
means for constructing the external object structure of said at least one referenced object based on class definition and object identification information from said storage medium (140); and
means for reading the object state of said at least one referenced object from said storage medium (140); and
means for notifying the object persistence manager (120) of completed restoration of said at least one referenced object.

24. The system according to claims 22 or 23, characterized in that said object persistence manager (120) comprises:
a restore factory (124) for controlling the actual restoration of objects from said storage medium (140); and
a restore manager (126) for keeping track of restored objects and needed referenced objects and informing restored objects when needed referenced objects have been restored.
